(19) United States
(12) Patent Application Publication
(10) Pub. No.: US 2013/0256494 A1
(43) Pub. Date: Oct. 3, 2013

(54) PHOTO-FRAME SHAPED HOLDER

(71) Applicant: Shuo OU-YANG, New Taipei City (TW)

(72) Inventor: Shuo OU-YANG, New Taipei City (TW)

(21) Appl. No.: 13/844,052

(22) Filed: Mar. 15, 2013

(30) Foreign Application Priority Data
Mar. 30, 2012 (TW) 101205836

(51) Int. Cl. F16M 13/00

(52) U.S. Cl. CPC F16M 13/00
USPC 248/450

(57) ABSTRACT

A photo-frame shaped holder is disclosed, including a photo frame panel provided with a first window, a frame slot unit disassemblably installed at the backside of the first window of the photo frame panel, and a supporting plate pivotally arranged in the frame slot unit. The frame slot unit is provided with a second window at the front side thereof. When the portable audio and video object is placed in the photo-frame shaped holder in a stand-up state, the first window and the second window of the photo-frame shaped holder correspond to the screen of the portable audio and video object and the shape of the portable audio and video object is hidden.

### RELATED APPLICATIONS

This application claims priority to Taiwan Application Serial Number 101205836, filed Mar. 30, 2012, which is herein incorporated by reference.

### BACKGROUND

1. Technical Field

The present disclosure relates to a holder. More particularly, the to present disclosure relates to a photo-frame shaped holder for placing a portable audio and video object.

2. Description of Related Art

Portable audio and video objects such as smart phones, panel is computers are generally have a lot of photographs stored therein. At leisure times or intervals of working, people of course wants to view and enjoy these photographs at any moment.

During viewing of photographs on the portable audio and video object, a better viewing effect can be obtained when the portable audio and video object stands up. For example a conventional cell phone holder can be used for placing a cell phone thereon.

People may also want to obtain a beautiful and cheerful visual effect when viewing the photographs displayed on the portable audio and video object. However, typical electronic products such as the portable audio and video objects most have rigescent shapes. The conventional holder is only a pedestal body purely having a placing function, and thus when the portable audio and video object is placed on the conventional holder, the conventional holder cannot change the visual appearance of the portable audio and video object. Due to the disadvantage that the conventional holder cannot shield the rigescent shape of the portable audio and video object, the viewing effect is adversely affected.

### SUMMARY

The present disclosure provides a photo-frame shaped holder which can hide the rigescent shape of a portable audio and video object.

An aspect of the present disclosure provides a photo-frame shaped holder for placing a portable audio and video object. The photo-frame shaped holder includes a photo frame panel, a frame slot unit and a supporting plate combined with each other. The photo frame panel is provided with a first window. The frame slot unit is disassemblably installed at the backside of the first window of the photo frame panel. The frame slot unit is provided with a second window at the front side thereof, and the frame slot unit has an accommodating chamber communicated with the first window and the second window. The supporting plate is pivotally arranged in the frame slot unit, and can be folded inwardly or outwardly towards the direction of the photo frame panel.

According to an embodiment of the present disclosure, the frame slot unit includes a carrier plate and a frame body integrated as a whole. The carrier plate is provided with a second window, and the accommodating chamber is formed between the frame body and the carrier plate. According to an embodiment of the present disclosure, the frame body has two opposite side plates; through holes are respectively set at corresponding positions of the side plates; the backside of the frame body has an upper frame strip and a lower frame strip connected to the twp side plates; and an hollow hole is arranged between the upper frame strip and the lower frame strip. Convex shafts are respectively set at two sides of the supporting plate; the supporting plate passes through the hollow hole in the frame body; and the convex shaft is pivotally accommodated in the through hole.

According to an embodiment of the present disclosure, the supporting to plate is curved and has a curved turning part. The two convex shafts are respectively arranged at two sides of the curved turning part. The supporting plate uses the curved turning part as a shaft and has a bottom terminal portion and a top terminal portion opposite to each other. A slip-limiting rubber cover covers the top terminal portion.

According to an embodiment of the present disclosure, a convex buckle is set at a corresponding position on the inner face of each of the two side plates of the frame body.

According to an embodiment of the present disclosure, an opening functioning as the channel of wires of a charger is arranged at the bottom of the frame body.

According to an embodiment of the present disclosure, a raising block is arranged on the inner face at the bottom of the frame body, and the raising block is provided with a through opening communicated with the opening.

According to an embodiment of the present disclosure, a raising-strip hole is arranged at each of the two side plates of the frame body, and a raising strip passes through the raising-strip hole to be internally extended in the frame body.

According to an embodiment of the present disclosure, on the backside of the photo frame panel at least one spring sheet is pivotally arranged at each of the two opposite sides of the first window, and the spring sheet is rotated to fasten the side edges at two opposite sides of the frame slot unit.

According to an embodiment of the present disclosure, on the backside of the photo frame panel a recess is arranged at the periphery of the first window, a variable window plate is accommodated in the recess, positioned between the photo frame panel and the frame slot unit, and the variable window plate is provided with a third window communicated with the first window and the second window.

The photo-frame shaped holder according to an aspect of the present disclosure can place the portable audio and video object in a stand-up state, and the windows of the photo-frame shaped holder correspond to the screen of the portable audio and video object and the shape of the portable audio and video object is hidden.

### BRIEF DESCRIPTION OF THE DRAWINGS

FIG. 1 is an appearance view of a photo-frame shaped holder according to an embodiment of the present disclosure viewing from the front side;

FIG. 2 is an appearance view of a photo-frame shaped holder according to an embodiment of the present disclosure viewing from the rear side; FIG. 3 is an explored view of the photo-frame shaped holder shown in FIG. 2;

FIG. 4 is a schematic sectional view of the photo-frame shaped holder shown in FIG. 2 during usage, which shows a state that the top terminal portion of the supporting plate is stretched outwardly to place a portable audio and video object in the accommodating slot;

FIG. 5 is another schematic sectional view of the photo-frame shaped holder shown in FIG. 2 during usage, which shows a state that the top terminal portion of the supporting plate is pressed inwardly to retain a portable audio and video object, the photo-frame shaped holder being standing up on a platform;

FIG. 6 is a schematic view of the photo-frame shaped holder shown in FIG. 3 with a raising block set in the frame body thereof; and

FIG. 7 is a schematic view of the photo-frame shaped holder shown in FIG. 3 with a raising strip set in the frame body thereof.

### DETAILED DESCRIPTION

The foregoing and other technical contents, features and functions of the present disclosure will be clearly presented through the following detailed description of embodiments with reference to the accompanying drawings.

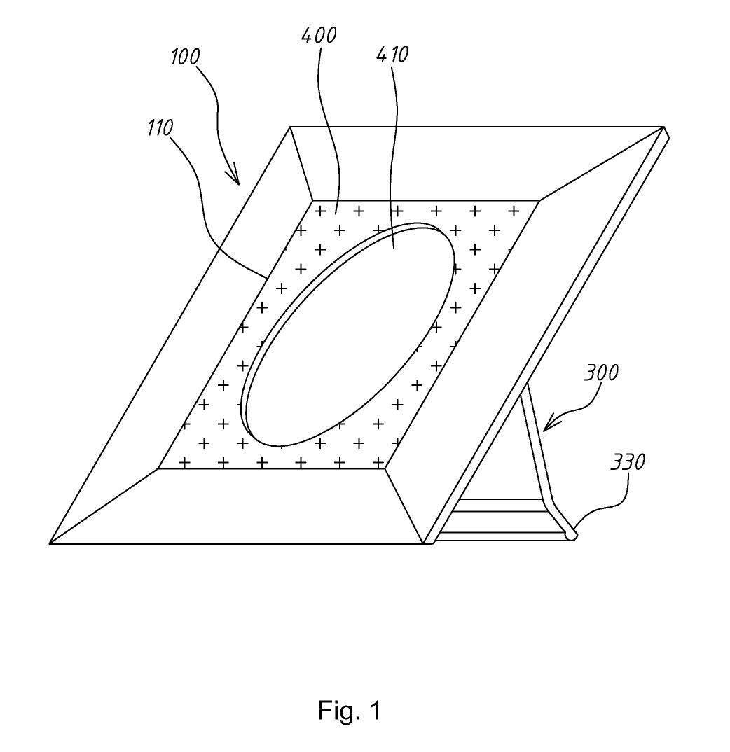

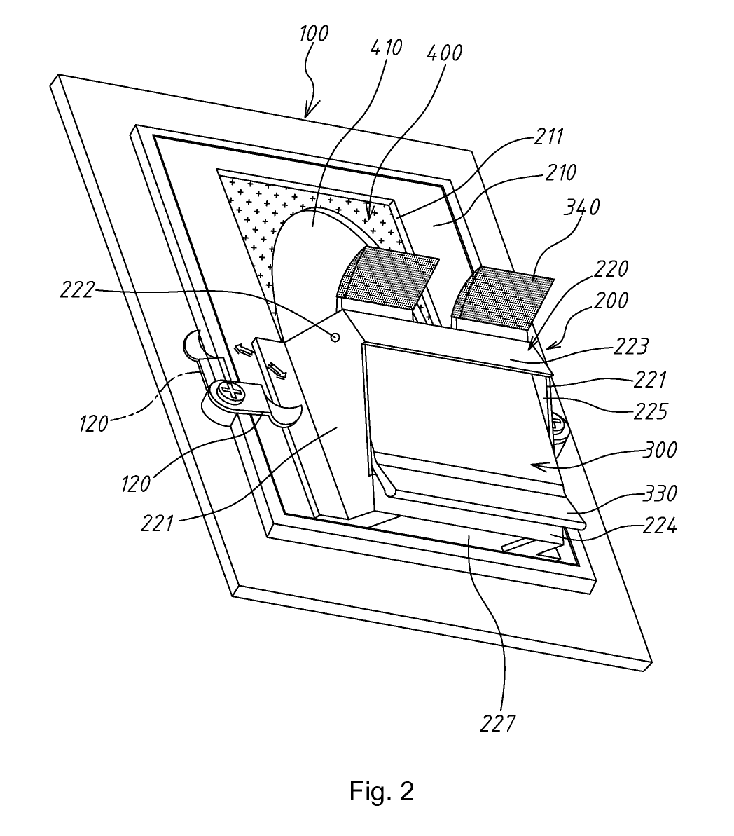

Referring to FIGS. 1-3, a photo-frame shaped holder according to an embodiment of the present disclosure includes a photo frame panel 100, a frame slot unit 200, a supporting plate 300 and a variable window plate 400.

The photo frame panel 100 is provided with a first window 110. On the backside of the photo frame panel 100, two spring sheets 120 are pivotally arranged at two opposite sides of the first window 110 and can be rotated to different positions. That is, the spring sheet 120 can be rotated to fasten the side edges at two opposite sides of the frame slot unit 200 through pressing, and thus the photo frame panel 100 and the frame slot unit 200 are integrated as a whole. Alternatively, the spring sheet 120 may be rotated to depart from the range of the frame slot unit 200 so as to separate the photo frame panel 100 and the frame slot unit 200. On the backside of the photo frame panel 100, a recess 130 is formed at the periphery of the first window 110 for accommodating the variable window plate 400 therein.

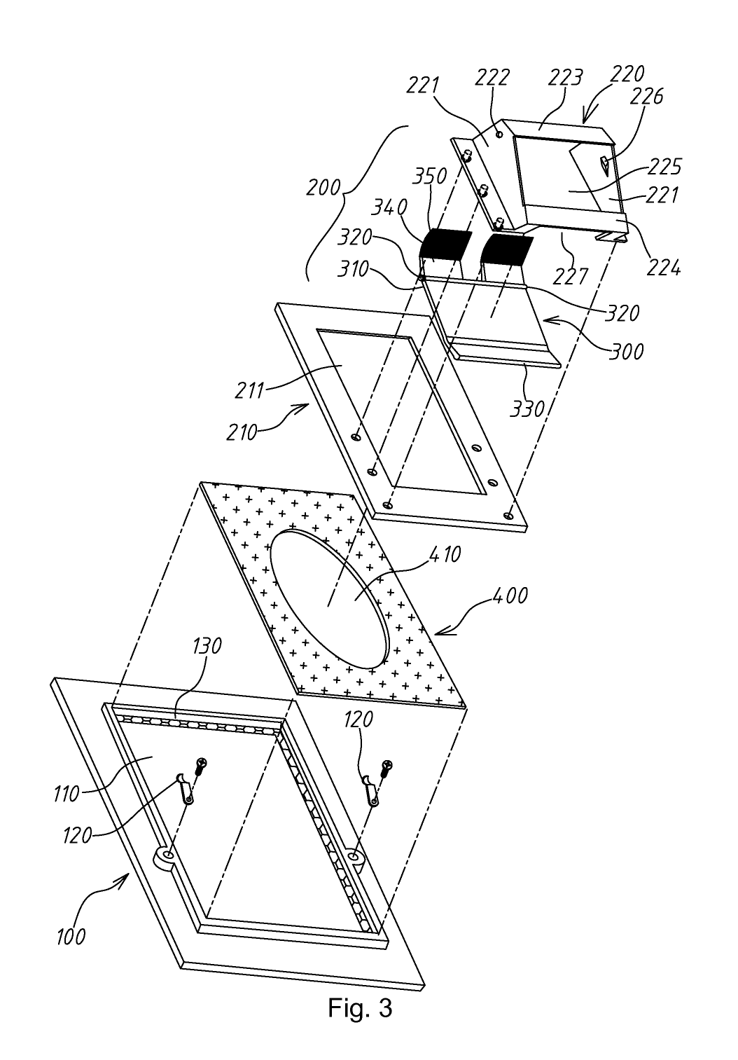

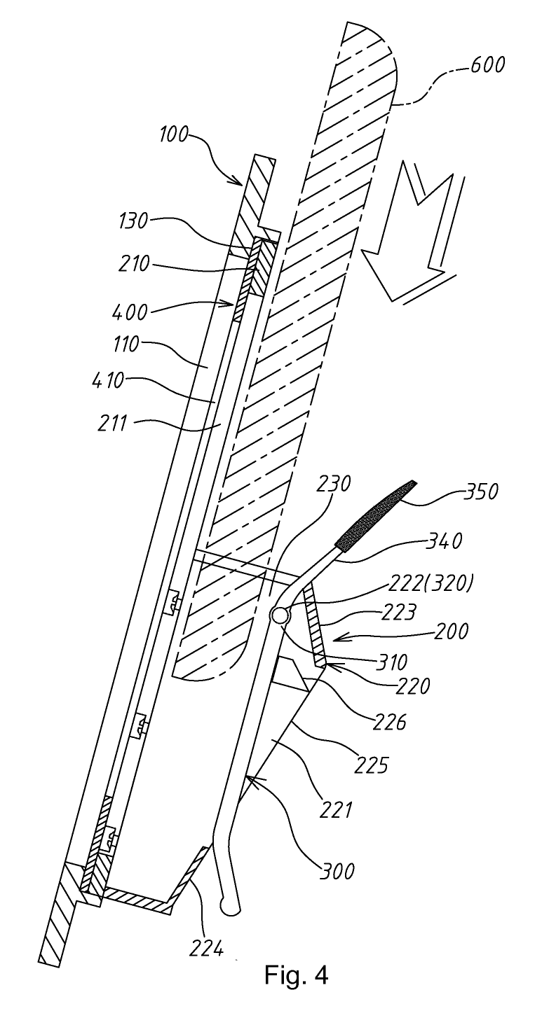

The frame slot unit 200 is disassemblably installed on the backside of the first window 110 of the photo frame panel 100. A second window 211 corresponding to the first window 110 is arranged on the front side of the frame slot unit 200, and the frame slot unit 200 has an accommodating chamber 230 (referring both to FIGS. 4 and 5) communicated with the first window 110 and the second window 211.

The frame slot unit 200 includes a carrier plate 210 and a frame body 220 integrated as a whole. The above-mentioned second window 211 is arranged on the carrier plate 210, and the above-mentioned accommodating chamber 230 is formed between the frame body 220 and the carrier plate 210. The carrier plate 210 and the frame body 220 can be combined through an ultrasonic welding or lock joint manner.

The frame body 220 has two opposite side plates 221, and a through hole 222 is set at a corresponding position of each of the side plates 221. Moreover, the backside of the frame body 220 has an upper frame strip 223 and a lower frame strip 224 connected with the two side plates 221, and an hollow hole 225 is arranged between the upper frame strip 223 and the lower frame strip 224 for passing through by the following-described supporting plate 300. Convex buckle 226 are respectively set at corresponding positions on the inner face of the two side plates 221. When the top terminal portion of the supporting plate 300 is folded outwards, the convex buckle 226 is used for retaining the supporting plate. An opening 227 is arranged at the bottom of the frame body 220, which is communicated with the accommodating chamber 230 and functions as a channel for wires of a charger (not shown). The supporting plate 300 is pivotally arranged in the frame slot unit 200, and can be folded inwards or outwards towards the direction of the photo frame panel 100. The supporting plate 300 is curved and has a curved turning part 310. The supporting plate 300 uses the curved turning part 310 as the shaft and has a bottom terminal portion 330 and a top terminal portion 340 opposite to each other. A slip-limiting rubber cover 350 covers the top terminal portion 340. Convex shafts 320 are respectively set at two sides of the curved turning part 310 of the supporting plate 300. The supporting plate 300 passes through the hollow hole 225 of the frame body 220, and the convex shafts 320 arranged at two sides of the supporting plate 300 is pivotally accommodated in the through holes on the two side plates 221 of the frame body 220. Therefore, the supporting plate 300 still can be rotated inwardly or outwardly with the two convex shafts 320. The slip-limiting rubber cover 350 has the function of limiting the slip and avoiding the scrape of the following described portable audio and video object 600.

The variable window plate 400 is accommodated in the recess 130 of the photo frame panel 100, positioned between the photo frame panel 100 and the frame slot unit 200. The variable window plate 400 is provided with a third window 410 communicated with the first window 110 of the photo frame panel 100 and the second window 211 of the frame slot unit 200. The variable window plate 400 can be a plurality of plates with third windows 410 having different patterns. The variable window plate 400 is accommodated between the photo frame panel 100 and the frame slot unit 200 and can be selected from the above-mentioned different patterned variable window plates 400 to generate different visual windows.

Referring to FIG. 4, under a non-use state, the top terminal portion 340 of the supporting plate 300 of the photo-frame shaped holder is stretched outwardly to release the accommodating chamber 230 thereof. Therefore, when the photo-frame shaped holder is used, a portable audio and video object 600 such as smart phones can be directly placed in the accommodating chamber 230, and the screen (not shown) of the portable audio and video object 600 faces the photo frame panel 100.

Thereafter, as shown in FIG. 5, the supporting plate 300 is rotated to press the top terminal portion 340 inwardly and enable the slip-limiting rubber cover 350 to press on the backside of the portable audio and video object 600, and thus the portable audio and video object 600 is accommodated in the accommodating chamber 230 stably. The slip-limiting rubber cover 350 has the function of limiting the slip and avoiding the scrape of the backside of the portable audio and video object 600. Meanwhile, the side edge of the supporting plate 300 adjacent to the bottom terminal portion 330 passes backwards through the convex buckle 226 on the side plate 221 of the frame body 220, and the convex buckle 226 and the bottom edge of the upper frame strip 223 jointly limit action of the supporting plate 300 to maintain the pressing state of the supporting plate 300. Under this state, the bottom terminal portion 330 of the supporting plate 300 and the bottom edge of the photo frame panel 100 can jointly support the entire photo-frame shaped holder on a platform 700 such as on a desk and enable the photo frame panel 100 to be placed with an elevation angle backwards. Accordingly, the portable audio and video object 600 is placed in the photo-frame shaped holder in a stand-up state, so that a user can conveniently view the photographs stored in the portable audio and video object 600 through the overlapped first window 110, third window 410 and second window 211. The rigescent shape of the portable audio and video object 600 can be shielded by the photo frame panel 100. The screen of the portable audio and video object 600 can be modified by the third window 410 of the variable window plate 400. Accordingly the rigescent shape of the portable audio and video object can be hidden and the photographs stored in the portable audio and video object can be viewed with a beautiful and cheerful visual effect as a photo frame is used.

The portable audio and video object 600 can still be charged when placed in the photo-frame shaped holder of the present disclosure. That is, wires of a charger (not shown) can pass through the opening 227 at the bottom of the frame body 220 so as to charge the portable audio and video object 600. Moreover, when the above-mentioned place state of the portable audio and video object 600 is applied at night the holder can also function as a night light.

When it needs to take the portable audio and video object 600 out from the photo-frame shaped holder, the supporting plate 300 is rotated reversely to make the side edge of the supporting plate 300 passing forwards through the convex buckle 226 on the side plate 221 of the frame body 220, and thus the top terminal portion 340 of the supporting plate 330 is stretched outwardly to release the press on the portable audio and video object 600, so as to take the portable audio and video object 600 out.

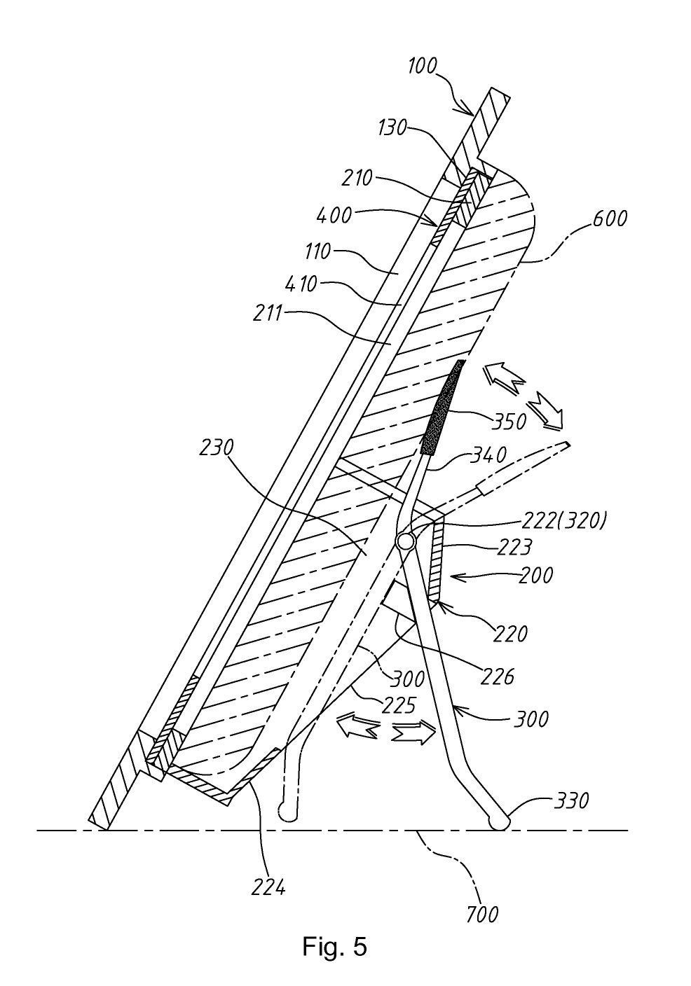

Furthermore, referring to FIG. 6, in order to match with a portable audio and video object with a short size in height, a raising block 510 is arranged on the inner face at the bottom of the frame body 220 to raise the bottom height of the accommodating chamber 230, and thus the height positions of the screen (not shown) of the portable audio and video object, the first window 110, second window 211 and third window 410 are matched. The raising block 510 is provided with a through opening 511 communicated with the opening 227, which functions as the channel of wires of a charger (not shown) for charging the portable audio and video object.

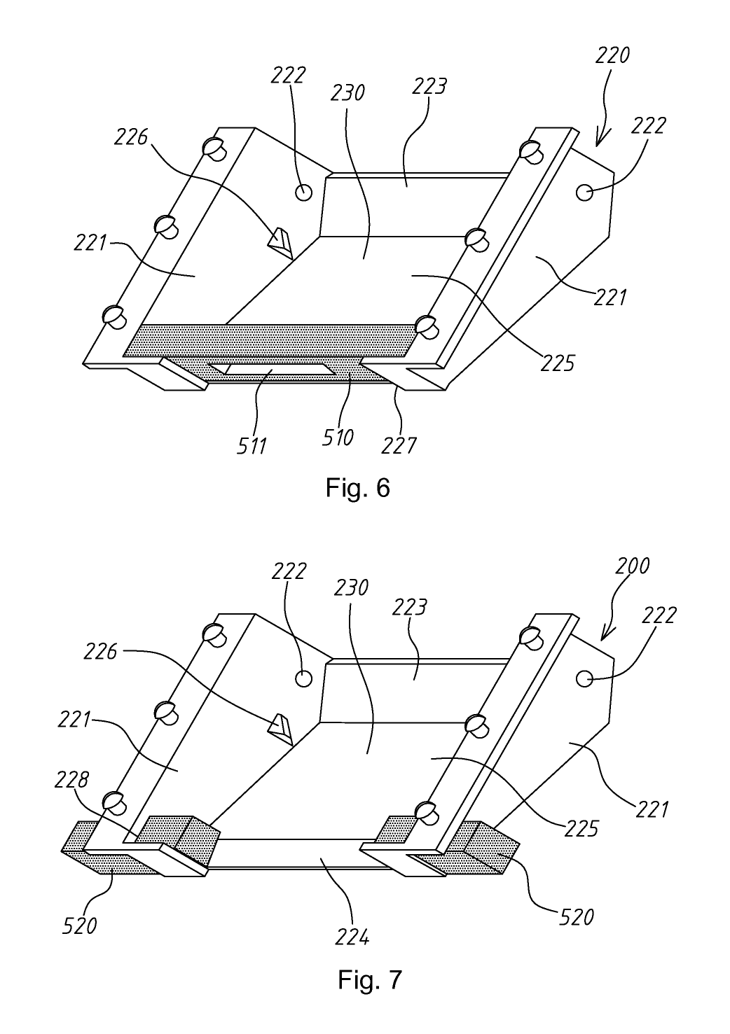

Referring to FIG. 7, for another implemented structure for raising the bottom of the accommodating chamber 230, a raising-strip hole 228 is arranged at each of the two side plates of the frame body 220, and a raising strip 520 passes through the raising-strip hole 228 to be internally extended in the frame body 220. Accordingly the bottom of the accommodating chamber 230 is raised for placing the portable audio and video object with a short size.

The photo-frame shaped holder according to an embodiment of the present disclosure can be used for placing the portable audio and video object therein stably in a stand-up state, and can hide the rigescent shape of the portable audio and video object, thereby when the photographs displayed by the portable audio and video object is viewed achieving a beautiful and cheerful visual effect as a photo frame is used.

What is claimed is:

1. A photo-frame shaped holder for placing a portable audio and video object, comprising:
a photo frame panel provided with a first window;
a frame slot unit disassemblably installed at a backside of the first window of the photo frame panel, wherein the frame slot unit is provided with a second window at a front side thereof, and the frame slot unit has an accommodating chamber communicated with the first window and the second window; and
a supporting plate pivotally arranged in the frame slot unit, capable of being folded inwardly or outwardly towards the direction of the photo frame panel.

2. The photo-frame shaped holder of claim 1, wherein the frame slot unit comprises a carrier plate and a frame body combined as a whole, the second window is provided on the carrier plate, and the accommodating chamber is formed between the frame body and the carrier plate.

3. The photo-frame shaped holder of claim 2, wherein the frame body has two opposite side plates, the side plates have through holes, the through holes are respectively set at corresponding positions of the side plates, the backside of the frame body is provided with an upper frame strip and a lower frame strip connected to the two side plates, an hollow hole is arranged between the upper frame strip and the lower frame strip, each of two sides of the supporting plate has a convex shaft, the supporting plate passes through the hollow hole of the frame body and the convex shafts are pivotally accommodated in the through holes respectively.

4. The photo-frame shaped holder of claim 3, wherein the supporting plate is curved and has a curved turning part, the two convex shafts are respectively arranged at two sides of the curved turning part, the supporting plate uses the curved turning part as an axis and has a bottom terminal portion and a top terminal portion opposite to each other, and a slip-limiting rubber cover covers the top terminal portion.

5. The photo-frame shaped holder of claim 4, wherein the two side plates of the frame body have convex buckles, the convex buckles are respectively set at corresponding positions on inner faces of the two side plates.

6. The photo-frame shaped holder of claim 3, wherein an opening is set at a bottom of the frame body.

7. The photo-frame shaped holder of claim 6, wherein a raising block is arranged on an inner face of the bottom of the frame body, and the raising block is provided with a through opening communicated with the opening at the bottom of the frame body.

8. The photo-frame shaped holder of claim 6, wherein a raising-strip hole is arranged at each of the two side plates of the frame body, and a raising strip passes through the raising-strip hole to be internally extended in the frame body.

9. The photo-frame shaped holder of claim 1, wherein at least one spring sheet is pivotally arranged at each of two opposite sides of the first window on the backside of the photo frame panel, and the spring sheet is rotated to fasten side edges at two opposite sides of the frame slot unit.

10. The photo-frame shaped holder of claim 1, wherein a recess is arranged at the periphery of the first window on the backside of the photo frame panel, a variable window plate is accommodated in the recess and positioned between the photo frame panel and the frame slot unit, and the variable window plate is provided with a third window communicated with the first window and the second window.
